(19) United States
(12) Patent Application Publication
(10) Pub. No.: US 2008/0054728 A1
(43) Pub. Date: Mar. 6, 2008

(54) Systems and methods for providing electrical power from an alternating current power source

(76) Inventor: Tom Watson, Madison, AL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/516,465

(22) Filed: Sep. 6, 2006

(51) Int. Cl. H02H 3/00

(52) U.S. Cl. 307/130

(57) ABSTRACT

In general, the present disclosure pertains to systems and methods for providing electrical power from an alternating current (AC) power source to direct current (DC) components. A power supply system in accordance with one exemplary embodiment of the present disclosure has a power supply element and a load controller, and the power supply element receives an AC signal from an AC power source. In this regard, the power supply element is directly connected to the hot wire carrying an AC signal from the AC power source. For each half cycle of the AC signal, the power supply element uses the AC signal to charge a capacitor during a small portion of the half cycle. During another portion of the same half cycle, the load controller may use the AC signal to power an AC load. During the cycle, the capacitor is discharged thereby providing DC power to various components in the system. Thus, power from the AC signal is effectively shared between the AC load and the DC components, and there is no need for the power supply circuit to be connected directly to the neutral wire.

### RELATED ART

This application claims priority to U.S. Provisional Application No. (to be determined), attorney docket no. 320306-1060, entitled “Systems and Methods for Providing Electrical Power from an Alternating Current Power Source,” and filed on Aug. 31, 2006, which is incorporated herein by reference.

### RELATED ART

Many conventional power supply circuits receive an alternating current (AC) power signal across two wires and convert the AC signal into a direct current (DC) to supply various DC component with electrical power. One of the wires, sometimes referred to as “neutral,” is typically grounded, and the other wire, sometimes referred to as “hot,” propagates an AC signal that varies in voltage over time.

Unfortunately, in some situations, both the hot and neutral wires from an AC power source are not readily available for one or more DC components of an electrical system. In such situations, an alternative power source, such as a battery, may be installed to power the DC components. However, adding a battery can undesirably increase the cost and/or size of the electrical system. Further, it is well-known that batteries need replacing or recharging over time, thereby increasing the maintenance cost of the electrical system.

In some situations, only one of the hot and neutral wires from an AC power source may be readily available. For example, when retrofitting a house or other building with a centralized or networked lighting system, it may be desirable to embed intelligence at a light switch. Therefore, it may be desirable to replace a conventional light switch with one that contains DC components, such as a microprocessor, for intelligently controlling the operational state of one or more light sources or other loads based on electronic inputs. However, many conventional light switches are directly connected only to the hot wire from an AC power source.

In this regard, if the light source being controlled by the switch, is to be activated (i.e., turned “on”), then the switch electrically couples the hot wire to a wire running to the light source. Otherwise, the light switch electrically isolates the hot wire from the wire running to the light switch. Thus, by controlling whether the hot wire is electrically coupled to the light source, the switch can control the operational state of the light source, and there is no need for the light switch to be directly connected to the neutral wire, which is directly connected to the light source but not the switch.

However, to provide power from the same AC power source that is used to power the light source, many conventional power supply circuits for converting AC to DC would require access to the neutral wire. Unfortunately, the neutral wire may be located far from the switch and connecting the new switch to the neutral wire can be time consuming and burdensome. Indeed, a user retrofitting a house or other building with a centralized or networked lighting system may expend considerable time, effort, and money in installing wires into the walls of the house or other building in order to connect the new switches to the neutral wire.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating a power supply system implemented within a switching unit of a lighting system in accordance with an exemplary embodiment of the present disclosure.

FIG. 2 is a block diagram illustrating an exemplary instruction execution device that can be used to run a switch manager and a power manager depicted in FIG. 1 when the switch and power managers are implemented in software.

FIG. 3 is a graph illustrating an exemplary AC signal propagated by a hot wire depicted in FIG. 1.

FIG. 4 is a block diagram illustrating an exemplary embodiment of a power supply element and a load controller depicted in FIG. 1.

FIG. 5 is a graph illustrating a rectified signal based on the AC signal depicted in FIG. 3.

FIG. 6 is a graph illustrating an exemplary signal transmitted by the exemplary power supply element depicted in FIG. 4.

FIG. 7 is a graph illustrating an exemplary signal used to charge a capacitor depicted in FIG. 4.

FIG. 8 is a graph illustrating an exemplary signal transmitted by the exemplary power supply element depicted in FIG. 4.

FIG. 9 is a graph illustrating an exemplary control signal for activating an AC switch depicted in FIG. 4 during an exemplary half-cycle.

FIG. 10 is a flow chart illustrating an exemplary use and operation of the power supply system depicted in FIG. 1.

### DETAILED DESCRIPTION

In general, the present disclosure pertains to systems and methods for providing electrical power from an alternating current (AC) power source to direct current (DC) components. A power supply system in accordance with one exemplary embodiment of the present disclosure has a power supply element and a load controller, and the power supply element receives an AC signal from an AC power source. In this regard, the power supply element is directly connected to the hot wire carrying an AC signal from the AC power source. For each half cycle of the AC signal, the power supply element uses the AC signal to charge a capacitor during a small portion of the half cycle. During another portion of the same half cycle, the load controller may use the AC signal to power an AC load, if desired. During the cycle, the capacitor is discharged thereby providing DC power to various components in the system. Thus, power from the AC signal is effectively shared between the AC load and the DC components, and there is no need for the power supply circuit to be connected directly to the neutral wire.

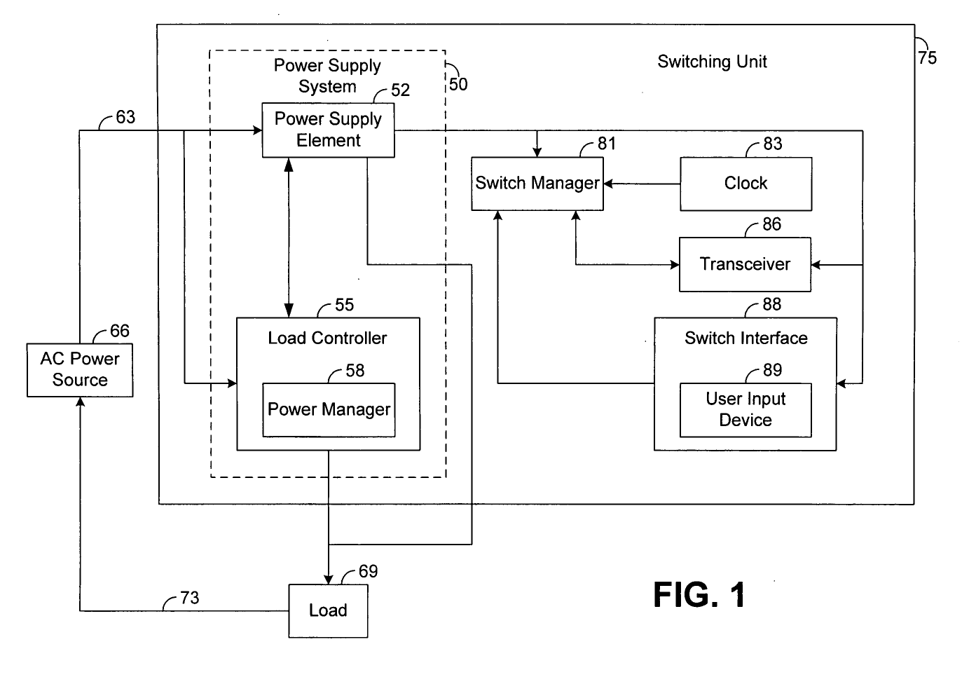

FIG. 1 depicts a power supply system 50 in accordance with an exemplary embodiment of the present disclosure. As shown by FIG. 1, the power supply system 50 comprises a power supply element 52 and a load controller 55, which comprises a power manager 58. The power supply element 52 is directly connected to a wire 63, referred to as a “hot wire,” that carries an AC signal from an AC power source 66. Further, the load controller 55 is electrically coupled to at least one electrical load 69, such as a light source (e.g., a light emitting diode (LED), a light bulb, etc.), and provides an AC signal for powering the load 69 as desired. The load 69 is connected to the AC power source 66 via a wire 73, referred to as a “neutral wire,” which is preferably grounded.

In the example illustrated by FIG. 1, the power supply system 50 is implemented within a switching unit 75 of a centralized or networked lighting system, such as is described in commonly-assigned U.S. patent application Ser. No. (to be determined), attorney docket no. 320306-1020, entitled “Lighting Systems and Methods,” and filed on Aug. 31, 2006, which is incorporated herein by reference.

The exemplary switching unit 75 of FIG. 1 comprises a switch manager 81 for generally controlling the operation of the unit 75 and a clock 83. The switching unit 75 also comprises a transceiver 86 for enabling communication with other switching units or a base unit of a lighting system (not specifically shown), and the unit 75 comprises a switch interface 88 that has at least one user input device 89 for receiving inputs from a user. The components 81, 83, 86, and 88, as well as possibly other components not shown in FIG. 1, may be coupled to and receive DC power from the power supply element 52.

The power supply system 50 is described in the context of a centralized or networked lighting system for illustrative purposes. It should be noted that the power supply system 50 may be implemented in other types of systems and be used to provide DC power to other types of DC components. Moreover, the power supply system 50 may be used in any system in which it is desirable to convert AC power to DC, and the system 50 is particularly useful, with respect to other conventional power supply systems, when it is desirable to share power from the same AC power source between an AC load and at least one DC component.

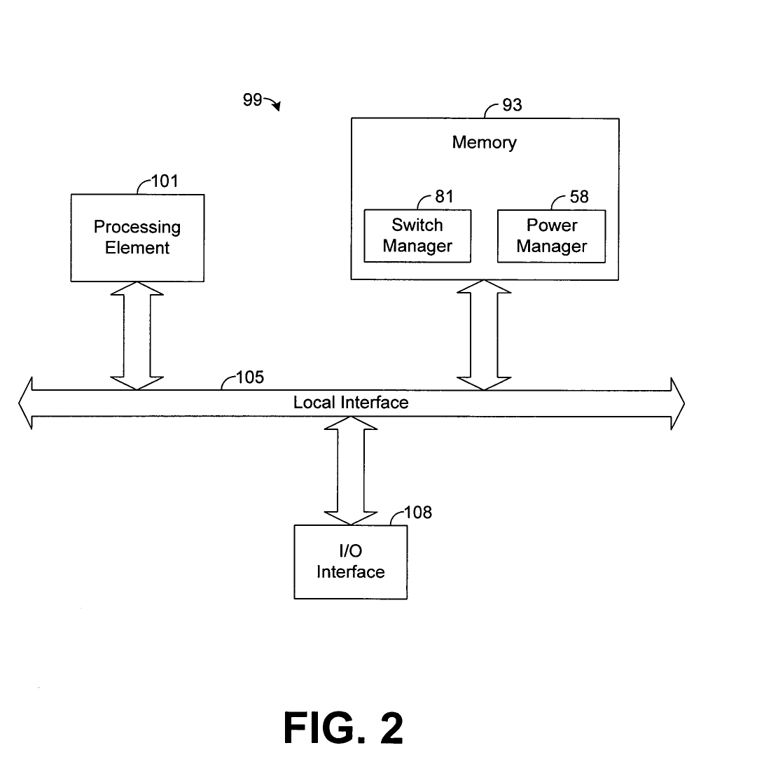

It should be noted that the power manager 58 and the switch manager 81 can be implemented in software, hardware, or a combination thereof. In an exemplary embodiment illustrated in FIG. 2, the power manager 58 and the switch manager 81, along with their associated methodology, are implemented in software and stored in memory 93 of an instruction execution device 99, such as a microprocessor.

Note that the power manager 58 and switch manager 81, when implemented in software, can be stored and transported on any computer-readable medium for use by or in connection with any instruction execution device that can fetch and execute instructions. In the context of this document, a “computer-readable medium” can be any means that can contain, store, communicate, propagate, or transport a program for use by or in connection with an instruction execution device. The computer readable-medium can be, for example but not limited to, an electronic, magnetic, optical, electromagnetic, infrared, or semiconductor device or propagation medium.

The exemplary embodiment of the instruction execution device 99 depicted by FIG. 2 comprises at least one conventional processing element 101, such as a central processing unit (CPU), that communicates to and drives the other elements within the device 99 via a local interface 105, which can include at least one bus. Furthermore, an input/output (I/O) interface 108 can be coupled to and enable communication between the device 99 and other components of the switching unit 75, including components of the load controller 55 and the power supply element 52.

The power supply element 52 is configured to convert electrical energy from the AC signal propagated by hot wire 63 to at least one DC power signal and to provide DC power to other components of the unit 75, such as the switch manager 81, transceiver 86, and/or switch interface 88, for example. Exemplary techniques for converting the AC signal into at least one DC signal will be described in more detail hereafter.

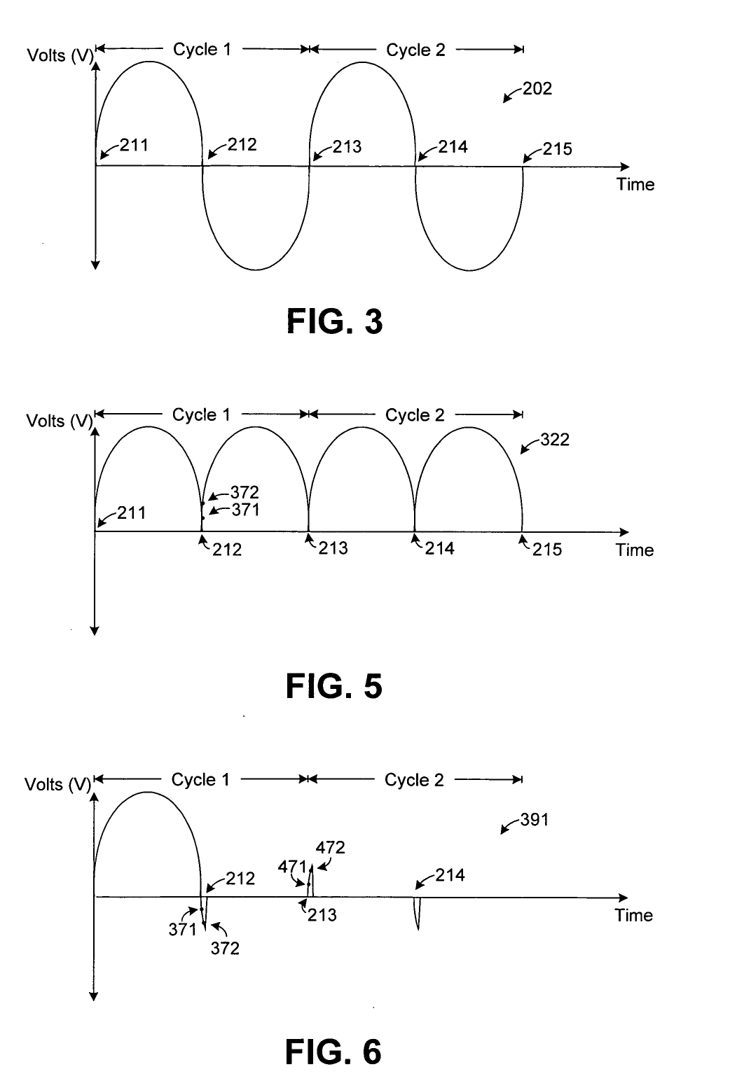

The power manager 58 is configured to detect zero-cross points in the AC signal carried by the hot wire 63. In this regard, FIG. 3 illustrates two cycles (cycle 1 and cycle 2) of an exemplary AC signal 202 propagated by the hot wire 63. In one embodiment, the AC signal is a 120 Volt (V), 60 Hertz (Hz) signal, but other voltages and frequencies are possible in other examples. A zero-cross point refers to points where the AC signal 202 crosses the zero voltage level. FIG. 3 illustrates five zero-cross points 211-215.

During time periods in which the load 69 is to be activated, the power manager 58 enables the load controller 55 to deliver power to the load 69 by allowing the AC signal 202 from the hot wire 63 to pass through the load controller 55 to the load 69. While the signal 202 is passing through the load controller 55 the power supply element 52 is unable to draw power from the signal 202. However, while the load 69 is activated, the power manager 58 allows the power supply element 52 to be periodically pulsed with energy from the AC signal 202 by periodically interrupting the flow of the AC signal 202 through the load controller 55. The power manager 58 controls the timing of the pulses based on the detected occurrences of the zero-cross points although other techniques for controlling the timing of the pulses are possible in other embodiments.

Moreover, the power supply element 52 comprises a capacitive element (not shown in FIG. 1) that stores energy from the aforementioned pulses so that electrical energy can be derived from the capacitive element between pulses when the AC signal is flowing through the load controller 55. Thus, the power supply element 52 can continuously provide DC power to various components during time periods when the load is activated and drawing AC power from the signal 202 on hot wire 63. Accordingly, the power supply system 50 provides a power supply element 52 that is in-line with the load 69 being powered by an AC power source 66. In this regard, the power supply element 52 and the load controller 55 define a parallel circuit that is in series with the load 69 and the AC power source 66.

FIG. 4 illustrates exemplary embodiments of the power supply element 52 and load controller 55. The power supply element of FIG. 4 comprises an input filter 303 that is connected to the hot wire 63. In addition, the power supply element 52 comprises another filter 304 that is electrically coupled to an output of an AC switch 309, which controls whether the AC signal on hot wire 63 flows through the switch 309 to the load 69. In one exemplary embodiment, the AC switch 309 comprises a TRIAC (not specifically shown) that is controlled by the power manager 58, although the AC switch 309 may comprise other types of components in other examples. When the TRIAC is enabled, the AC signal 202 is filtered by a filter 314 and then flows through the AC switch 309 to the load 69. When the TRIAC is disabled, the TRIAC electrically prevents current from flowing therethrough so that any current reaching the load 69 passes through the power supply element 52. Note that the impedance of the power supply element 52 is sufficiently high such that the current flowing therethrough is insufficient for causing the load 69 to emit light so that the load 69 can be completely turned off, if desired, despite the flow of current through the power supply element 52.

When the AC switch 309 is enabled and, therefore, allowing current to flow therethrough, the AC signal 202 flows through the load controller 55 and, in particular, the switch 309 instead of the power supply element 52. However, when the AC switch 309 is disabled and, therefore, prevents current from flowing therethrough, the AC signal 202 flows through the power supply element 52. When this occurs, the filter 303 receives and filters the AC signal 202 (FIG. 3) from the hot wire 63 and provides a filtered version of the AC signal 202 to a rectifier 316. In the embodiment shown by FIG. 4, the rectifier 316 is a bridge rectifier, although other types of known or future-developed rectifiers may be used in other embodiments. The rectifier 316 is coupled to the filter 304, and when the AC switch 309 is open (i.e., not allowing current flow) current flows from the filter 304 through the load 69.

The rectifier 316 rectifies the filtered AC signal and transmits this rectified signal to power supply circuits 326 and 327, as well as a voltage scaling circuit 328. In this regard, FIG. 5 depicts a rectified signal 322 representing the exemplary AC signal 202 of FIG. 3 after the signal 202 has passed through the rectifier 316, assuming that the load 69 is not activated and, therefore, drawing power through the load controller 55.

The voltage scaling circuit 328 scales the signal 322 such that the voltage of the output of the circuit 328 is within a suitable range for reception by a microprocessor 333. In the exemplary embodiment shown by FIG. 4, the power manager 58 and the switch manager 81 are implemented in software and are run by the microprocessor 333. The microprocessor 333 samples the scaled signal output by the voltage scaling circuit 328, and the power manager 58 detects the zero-cross points of the AC signal 202 based on these samples. In this regard, the power manager 58 can determine that a zero-cross point has been reached when the slope of the received voltage signal changes from negative to positive.

Each of the power supply circuits 326 and 327 is configured to receive and condition a rectified signal. Each of the power supply circuits 326 and 327 receives a control signal from the microprocessor 333 and outputs a DC signal, which is used to charge a capacitor 342. The power supply circuit 327 is configured such that it allows current to flow therethrough in the absence of an asserted control signal from the microprocessor 333. Further, the power supply circuit 328 is configured such that it prevents current from flowing therethrough in the absence of an asserted control signal from the microprocessor 333. Thus, initially, at start-up, the power supply circuit 326 is disabled and the power supply circuit 327 is enabled such that any current from the rectifier 316 flows through the circuit 327, as well as the voltage scaling element 328, but not circuit 326.

In one exemplary embodiment, the power supply circuit 326 comprises a MOSFET (not specifically shown) that is controlled by the control signal from the microprocessor 333. Until the MOSFET receives an asserted control signal from the microprocessor 333, the MOSFET is in an open state thereby preventing current from flowing through the power supply circuit 326. However, when the MOSFET receives an asserted control signal, the MOSFET switches to a closed state thereby allowing current to flow therethrough. In addition, the power supply circuit 327 comprises a zener diode (not specifically shown). In one embodiment, the zener diodes is connected in series with a transistor (not shown) that receives a control signal from the microprocessor 333. In the absence of an asserted control signal, the transistor is in a closed state allowing current to flow therethrough. When the control signal is later asserted, the transistor transitions to an open state preventing current from flowing therethrough. If desired, the zener diode of the power supply circuit 327 may be connected in parallel with the capacitor 342 to limit the voltage of the DC signal helping to protect components from unexpectedly high voltages. Various other types of devices may be used to implement either of the power supply circuits 326 and 327.

Initially, the power supply circuit 327 is enabled and supplies DC power to the capacitor 342. However, once the microprocessor 333 is powered up and the power manager 58 is able to lock onto the frequency of the AC signal 202 by detecting zero-cross points, the power manager 58 disables the power supply circuit 327 and thereafter selectively enables the power supply circuit 236, as will be described in more detail hereafter. Thus, initially, the power supply circuit 327 is used to provide a DC signal for charging the capacitor 342, but eventually the responsibility of charging the capacitor 342 is switched to the power supply circuit 326.

The capacitor 342 continuously discharges and provides a continuous DC signal that is filtered by a low-pass filter 349. A voltmeter 351 measures the voltage of the DC signal currently output by the capacitor 342 and transmits a value indicative of the measured voltage to the microprocessor 333. The filtered DC signal output by the low-pass filter 349 can be used to power various components of the switching unit 75. If any of the components require a voltage regulated power signal, a voltage regulator 355 can be used to provide a voltage regulated signal based on the filtered DC signal output by the low-pass filter 349. As a mere example, the microprocessor 333 may be powered by the signal output from voltage regulator 355.

As described above, FIG. 3 illustrates the AC signal 202 carried by the hot wire 63. Assume that the switch manager 81 determines the load 69 is to be deactivated (i.e., that the load 69 is not to emit light in the instant example where the load 69 represents a light source). In such an example, the power manager 58 disables the AC switch 309 such that no current flows through the switch 309. As a result, the AC power signal 202 flows through the power supply element 52, and the signal output by the filter 304 has a waveform similar to that shown by FIG. 3. In addition, the rectifier 316 transmits, to the power supply circuit 326, the signal 322 shown by FIG. 5.

In one exemplary embodiment, the power manager 58 controls the power supply circuit 326 such that the capacitor 342 periodically receives a pulse of electrical energy from the circuit 326. As an example, in one embodiment, the capacitor 342 receives a short pulse every half cycle of the AC signal 202. In this regard, upon detecting a zero-cross point, the power manager 58 enables the power supply circuit 326 for a short time period. As an example, the power manager 58 may enable the power supply circuit 326 for a predefined time period, such as 500 micro-seconds, or the power manager 58 may enable the power supply circuit 326 until the voltmeter 351 detects a voltage that exceeds a predefined threshold. As an example, after the zero-cross point 212 in FIG. 5, the power manager 58 may enable the power supply circuit 326 at point 371 and then disable the circuit 326 at point 372. Thus, from point 372 to at least the next zero-cross point 213, the circuit 326 is disabled. For the other half cycles, the power supply circuit 326 may be similarly enabled and disabled such that it is enabled only for a short time after the beginning of the half cycle.

Therefore, at the beginning of each half cycle, the capacitor 342 receives a short burst of energy, which is preferably sufficient for charging the capacitor 342 such that it continuously transmits, for at least the remainder of the half cycle, a voltage signal within a desired voltage range sufficient for meeting the DC power requirements of the switching unit 75. Note that if the voltage measured by voltmeter 351 is sufficiently high (e.g., above a specified threshold) during a given half cycle, the pulse to the capacitor 342 can be skipped by not enabling the power supply circuit 326 during the half cycle.

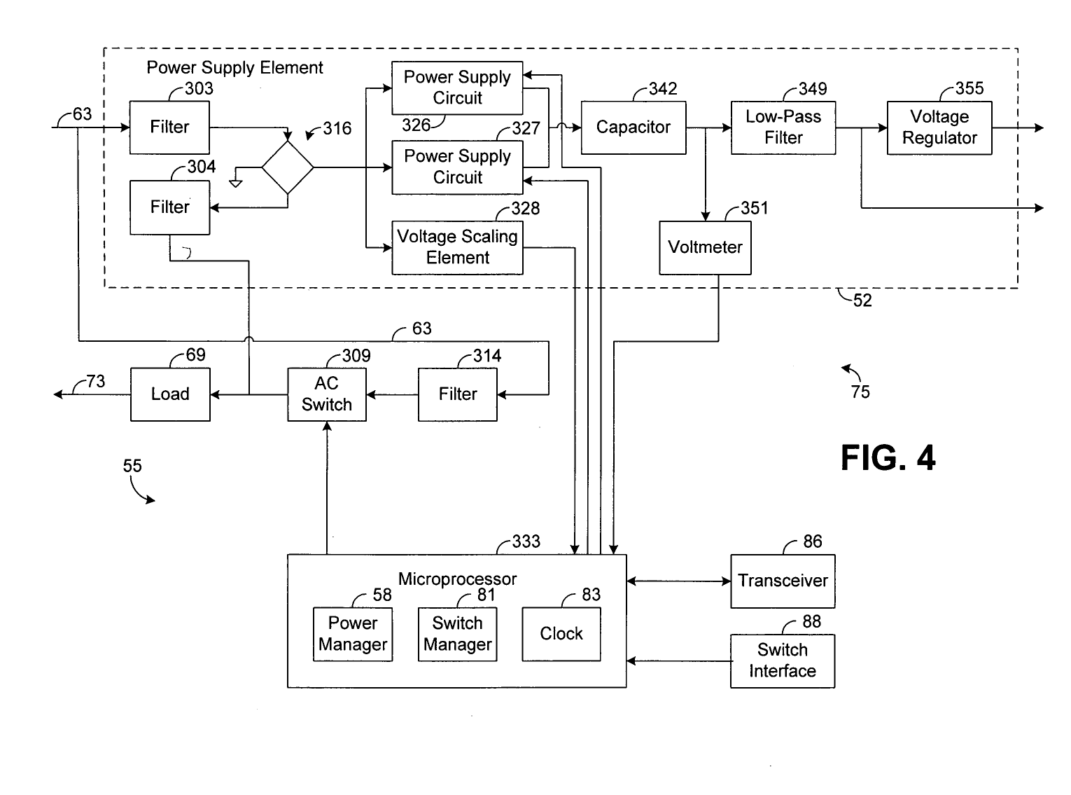

Assume that during the first half of cycle 1 in FIG. 3, the switch manager 81 notifies the power manager 58 that the load 69 is to be fully activated without any dimming. In other words, the state of the load 69 is to be changed such that it emits light at its highest possible brightness level. FIG. 6 illustrates an exemplary signal 391 output from the filter 304 for such an example.

Referring to FIG. 6, upon detecting the zero-cross point 212, the power manager 58 enables the power supply circuit 236 at a point 371 after the zero-cross point 212, as described above for the example where the load 69 is deactivated. The circuit 326 remains enabled for a short time until point 372. At point 372, the power manager 58 disables the circuit 236 such that current does not flow therethrough. Disabling of the circuit 236 may be based on an amount of time elapsed since point 371, a voltage sensed by the voltmeter 351, or some other factor. Moreover, enabling the circuit 326 at point 371 and disabling the circuit 326 at point 372 cause the circuit 326 to briefly provide an electrical pulse, which charges the capacitor 342. From point 372 to the next zero-cross point 213, the capacitor 342 discharges thereby providing a continuous DC signal to the low-pass filter 349 even though no current is flowing through either of the power supply circuits 326 and 327.

Shortly after point 372 when the power supply circuit 326 is disabled, the power manager 58 enables the AC switch 309 (FIG. 4) such that current begins flowing therethrough. Therefore, the AC signal 202 does not flow through the power supply element 52 and instead flows through the AC switch 309 thereby activating the load 69. Since the load 69 is fully activated, the AC switch 309 remains enabled for the remainder of the current half cycle (i.e., until about the next zero-cross point 213). Therefore, the voltage of the signal 391 approaches zero while the switch 309 is enabled, as shown by FIG. 6.

After the next zero-cross point 213, the power supply circuit 326 is enabled and the AC switch 309 remains disabled such that the capacitor 342 is again briefly charged between points 471 and 472 (FIG. 6). At point 472, the circuit 326 is disabled and shortly thereafter the AC switch 309 is enabled similar to what occurred for the preceding half cycle. Therefore, the capacitor 342 is again pulsed at the start of half cycle occurring at the zero-cross point 213. Moreover, the pattern of pulsing the capacitor 342 at the start of a half cycle and enabling the AC switch 309 for the remainder of the half cycle is repeated until the state of the load 69 is to be changed.

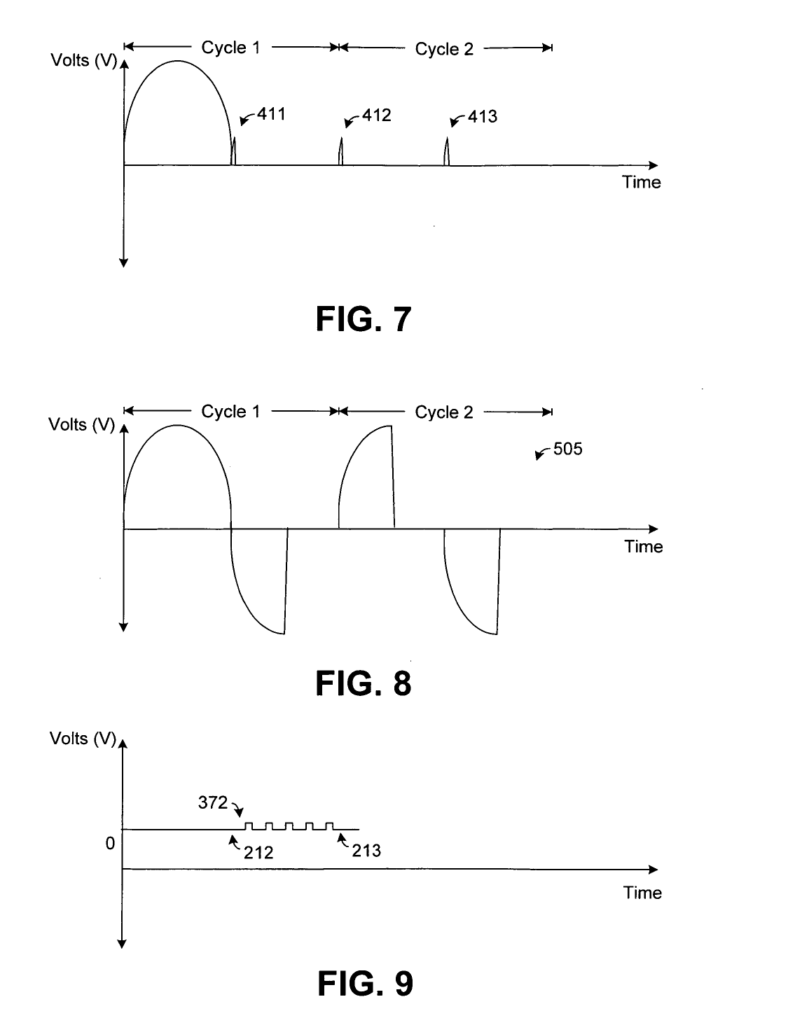

FIG. 7 depicts an exemplary signal 404 output from the rectifier 316 for the aforedescribed example. As shown by FIG. 7, a plurality of pulses 411-413 periodically occur at the start of each half cycle. These pulses 411-413 pass through and are conditioned by the power supply circuit 326 before being used to intermittently charge the capacitor 342.

Note that the brightness of the load 69 is not quite as high as compared to an embodiment that does not have the power supply circuit 326 in-line with the load 326 such that the AC signal 212 is not temporally shared between the power supply element 52 and the load controller 55 as is described above. In this regard, there is a finite time period in each half cycle in which the electrical power from the AC signal 202 is used to charge the capacitor 342. Thus, the overall amount of time that the load 69 receives electrical power from current passing through the AC switch 309 is reduced resulting in slightly lower brightness. In general, the shorter the duration of the time periods that the AC switch 309 is disabled per half cycle, the less of an effect the pulsing of the capacitor 342 has on the operational performance (e.g., brightness) of the load 69. Therefore, it is generally desirable to minimize the duration of the pulsing periods for charging the capacitor 342. One way to reduce such duration, is reducing the power requirements of the circuit 75 such that the capacitor 342 can be charged less per half cycle.

Note that, in some situations, it is possible for a particular zero-cross point to be missed. For example, depending on other tasks being performed by the microprocessor 333, such as communicating with the transceiver 86, it is possible for the microprocessor 333 to be busy with other tasks when a zero-cross point occurs. After locking on the AC power signal, the power manager 58 is aware of the approximate frequency of such signal, although this frequency may slightly drift in practice. If the time from the last detected zero-cross point exceeds a threshold (which can be equal to about half of the period of the AC signal) without another detection of a zero-cross point, the power manager 58 may determine that a zero-cross point has been missed. The power manager 58 may take various actions in response to a determination of a missed zero-point.

For example, the power manager 58 may briefly enable the power supply circuit 326 so that the capacitor 342 is pulsed. As an example, referring to FIG. 6, assume that the zero-cross point 212 is missed. In such an example, the power manager 58 may enable the current supply circuit 326 from the time of detection of the missed zero-cross point until a specified time period such that current supply circuit 326 is disabled at about point 372. If the voltage sensed by the voltmeter 351 exceeds a specified threshold (indicating that pulsing of the capacitor 342 for the current half cycle is unnecessary and/or undesirable), then enabling the current supply circuit 326 during the current half cycle can be skipped or, alternatively, stopped prior to point 372.

To provide a dimming function, the power manager 58 can be configured to adjust the duration that the AC switch 309 remains enabled during each half cycle. In this regard, in the example described above, the load 69 was to be fully activated, and the AC switch 309 remained enabled during the entire time approximately between the point when the circuit 326 was disabled to the next zero-cross point. For example, in FIG. 6, the AC switch 309 remained enabled between about point 372 and the zero-cross point 213, referred to hereafter as the “activation period.” A similar activation period existed for each of the other half cycles for as long as the load 69 was fully activated. To provide a dimming function, the duration of the activation period per half cycle may be decreased according to the dimming percentage desired.

For example, if the brightness is to be dimmed 50% such that the brightness of the load 69 is 50% of the maximum brightness level possible, the activation period may be reduced by about 50%. Thus, the signal 505 output from the input filter 303 may appear as shown in FIG. 8. In this regard, for each half cycle, rather than enabling the AC switch 309 after point 372, the AC switch 309 may be enabled approximately half way between point 372 and the next zero-cross point 213. The duration of the activation period for the other half cycles until the next change in the state of the load 69 may be similar such that the activation period per half cycle is reduced by approximately one-half. Reducing the activation period per half cycle in this manner should reduce the brightness of the load 69 by about one-half as well. In other examples, the duration of the activation period per half cycle may be adjusted in different manners to achieve different dimming percentages. Note that the dimming percentage may be based on user input, and the square law dimming algorithm may be used to select the desired dimming percentage based on such user input. Other types of algorithms may be used in other embodiments.

In an exemplary embodiment described above, the AC switch 309 comprises a TRIAC. For many conventional TRIAC designs, the TRIAC is enabled when its control signal transitions from a low voltage level to a high voltage level. Further, the TRIAC remains activated until its input voltage or output current falls below a threshold (e.g., falls to zero or a value close to zero). Thus, in at least one embodiment, about the time that a zero-cross point is reached, the AC switch 309 is automatically disabled regardless of the state of the control signal provided to it by the microprocessor 333. Therefore, for each half-cycle, the AC switch 309 is disabled at the zero-cross point marking the beginning of the half-cycle. As described above, once sufficient time has passed to allow the capacitor 342 to be pulsed, the AC switch 309 can be enabled, depending on the desired state of the load 69.

During the time period that the AC switch 309 is to remain enabled prior to the zero-cross point marking the end of the half-cycle, the control signal provided to the AC switch 309 can be periodically pulsed (i.e., repetitively transitioned from low to high to low) to ensure that the AC switch 309 remains activated despite phase differences in current and voltage of the AC signal. In this regard, if a TRIAC is used to implement the AC switch 309, such a TRIAC may be automatically disabled if the current of the AC signal approaches zero even though the input voltage is well above zero. Thus, by periodically pulsing the AC switch 309, the AC switch 309 can be quickly re-enabled if it is prematurely disabled due to phase differences between the current and voltage of the AC signal. As an example, during a time period that the AC switch 309 is to be enabled, the control signal might include 20 micro-second pulses that occur about every 140 micro-seconds.

FIG. 9 depicts an exemplary control signal 601 that may be used to enable the AC switch 309 for a half-cycle between zero-cross points 212 and 213 (FIG. 5) assuming that there is no dimming. As shown by FIG. 9, the pulses in the control signal 601 begin just after point 372 (FIG. 5), when the AC switch 309 is to be enabled, and stop prior to the zero-cross point 213, when the AC switch 309 is to be disabled. Thus, if the AC switch 309 is prematurely disabled due to the current of the AC signal falling below a threshold between points 372 and 213, the AC switch 309 is quickly re-enabled by the control signal 601. Various other techniques for ensuring that the AC switch 309 remains enabled, as desired, can be employed in other embodiments.

In addition, in one exemplary embodiment, the voltage scaling element 328 uses a resistive divider with capacitive filtering to allow load current to be monitored by the microprocessor 333 to at least some degree. For example, if the AC switch 309 is enabled, thereby activating the load 69, a drop in the voltage of the signal output by the element 328 is expected. If such a drop does not occur when the AC switch 309 is enabled, then the power manager 58 may determine that a component, such as AC switch 309, has failed. A failure notification could then be generated and communicated with a user. For example, a failure notification could be generated and transmitted to a user interface device (not shown), which displays or otherwise interfaces the notification to a user.

In addition, the signal from the voltage scaling element 328 could be repetitively sampled to enable the power manager 58 to determine whether the load 69 is reactive. In this regard, when the AC switch 309 is enabled, a reactive load 69 can result in a higher voltage for the signal output by the voltage scaling element 328 as compared to an embodiment having a load 69 that is purely resistive, such as a light source. Thus, if the microprocessor 333 senses a voltage higher than a specified threshold when the AC switch 309 is enabled, the power manager 58 may determine that the load 69 is reactive.

For many reactive loads, such as fans, a dimming function is not desirable. Moreover, if the power manager 58 determines that the load 69 is reactive, then the power manager 58 may be configured to refrain from performing dimming operations such that the power delivered to the load 69 is not reduced due to a dimming input when the AC switch 309 is enabled. In this regard, the power manager 58 automatically disables dimming operations. Thus, if a user connects a reactive load instead of a light source to the power supply system 50 or replaces a light source with a reactive load, such as a fan, it is unnecessary for the user to provide any inputs instructing the system 50 to disable dimming operations. In this regard, the power manager 58 senses the presence of a reactive load and automatically disables dimming operations for as long as the load 69 is reactive. Thereafter, when the load 69 is activated and is determined to be reactive, the power supply system 50 provides power to the load 69 as described above assuming that a load level of 100% is desired regardless of the dimming input being received.

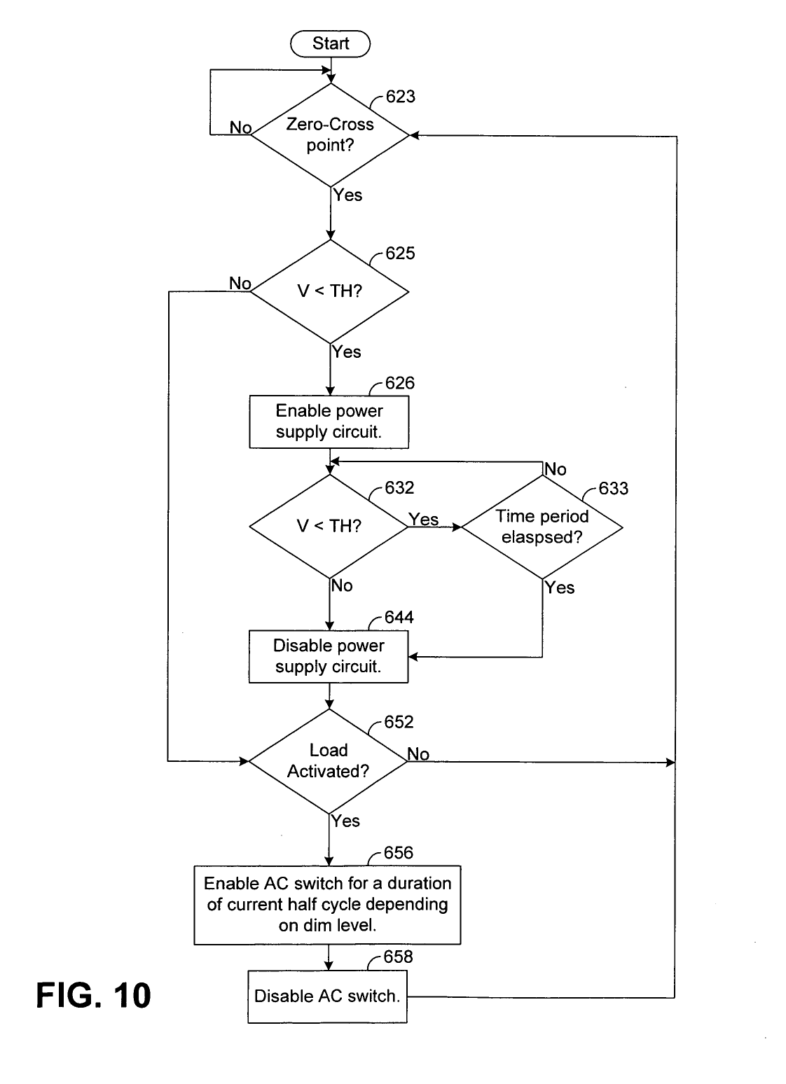

An exemplary use and operation of the power supply system 50 will now be described with particular reference to FIG. 10.

Initially, assume that the AC switch 309 and power supply circuits 326 and 327 are disabled. The power manager 58 monitors the samples of the signal output by the voltage scaling element 328 to detect a zero-cross point, as indicated by block 623 of FIG. 10. Upon detection of a zero-cross point, the power manager 58 enables the power supply circuit 326 if the voltage (V) sensed by the voltmeter 351 does not exceed a specified threshold (TH), as indicated by blocks 625 and 626 of FIG. 10. After enabling the power supply circuit 626, the power manager 58 keeps the circuit 626 enabled until the power manager 58 determines that the voltage sensed by voltmeter 351 exceeds the threshold or until a specified time period has elapsed since performance of block 626, as indicated by blocks 632 and 633. Once the power manager 58 determines that the threshold has been exceeded or that the specified time period has lapsed, the power manager 58 disables the power supply circuit 326, as indicated by block 644.

As indicated by block 652, the power manager 58 determines whether the load 69 is activated. If not, the power manager 58 returns to block 623 without enabling the AC switch 309. If the load 69 is activated, then the power manager 58 enables the AC switch 309 during the remainder of the current half cycle, as indicated by block 656. The AC switch 309 is then disabled close to the end of the current half cycle, as indicated by block 658. Moreover, the length of time that the AC switch 309 is enabled depends on the desired dim level of the load 69. For example, if a 20% dim level is desired, then the timing of block 656 can be controlled such that the AC switch 309 is enabled for only about 20% of the remainder of the current half cycle, as measured from block 644. As shown by FIG. 10, the power manager 58 returns to block 623 and repeats the aforedescribed process for the next half cycle. Note that the AC switch 309 may be disabled in block 658 by deasserting the control signal provided to the switch 309 by the microprocessor 333 such that the switch 309 is automatically disabled and remains disabled when its input voltage falls below a threshold.

In examples described above, the capacitor 342 is pulsed at the beginning of a half cycle. In other examples, the capacitor 342 may be pulsed during other portions of a half cycle, and the capacitor 342 may be pulsed at other frequencies such that the number of pulses per cycle is different. Various other modifications to the embodiments described above would be apparent to one of ordinary skill in the art upon reading this disclosure.

Now, therefore, the following is claimed:

1. A lighting system, comprising:
an alternating current (AC) power source;
a light source; and
a power supply system in series with the light source and the AC power source, the power supply system having a power supply element and an AC switch in parallel, the power supply element configured to convert power from the AC power source into a direct current (DC) signal for powering at least one DC component of the lighting system, the power supply system comprising logic configured to control the AC switch such that current from the AC power source is selectively passed through the AC switch and the power supply element during different time periods.

2. The lighting system of claim 1, wherein the power supply element has a capacitor, and wherein the power supply element is configured to transmit pulses to the capacitor thereby charging the capacitor with the pulses.

3. The lighting system of claim 2, wherein the logic is configured to control the AC switch such that the AC switch is disabled during each pulse and enabled between the pulses.

4. The lighting system of claim 1, wherein the power supply element comprises a power supply circuit for converting an AC signal from the AC power source to a direct current (DC) signal, and wherein the logic is configured to detect zero-cross points in the AC signal and to control the power supply circuit based on detections of the zero-cross points.

5. The lighting system of claim 4, wherein the logic is configured to enable the power supply circuit in response to at least one of the detections of the zero-cross points.

6. The lighting system of claim 5, wherein the power supply element further comprises a capacitor, and wherein the power supply circuit, when enabled, is configured to charge the capacitor.

7. The lighting system of claim 5, wherein the AC switch is automatically disabled when a voltage of the AC signal falls below a threshold voltage.

8. The lighting system of claim 6, the logic is configured to repetitively pulse the AC switch with a control signal when the logic determines that the AC switch is to be enabled.

9. The lighting system of claim 1, wherein the AC signal bypasses the power supply element when the AC switch is enabled.

10. A lighting system, comprising:
an alternating current (AC) power source;
a light source;
a power supply element configured to receive an AC signal from the AC power source and to provide a direct current (DC) signal based on the AC signal, the power supply element having a power supply circuit and a capacitor, the power supply circuit configured to charge the capacitor with intermittent pulses based on the AC signal, the capacitor configured to transmit the DC signal; and
an AC switch in parallel with the power supply element,
wherein the power supply element and the AC switch are in series with the AC power source and the light source.

11. The lighting system of claim 10, further comprising logic configured to control the AC switch such that the AC switch is disabled during each of the intermittent pulses and enabled between the intermittent pulses.

12. The lighting system of claim 11, wherein the logic is configured to detect zero-cross points in the AC signal and to control the power supply circuit based on detections of the zero-cross points.

13. The lighting system of claim 12, wherein the logic is configured to enable the power supply circuit in response to at least one of the detections of the zero-cross points.

14. The lighting system of claim 12, wherein the AC switch is automatically disabled when a voltage of the AC signal falls below a threshold voltage.

15. The lighting system of claim 10, wherein the AC signal bypasses the power supply element when the AC switch is enabled

16. A power supply system, comprising:
a power supply element having a power supply circuit and a capacitor, the power supply element configured to receive an alternating current (AC) signal and to charge the capacitor with intermittent pulses based on the AC signal, the capacitor configured to transmit a direct current (DC) signal;
an AC switch in parallel with the power supply element; and
logic configured to selectively activate the AC switch, wherein the AC signal bypasses the power supply element when the AC switch is disabled.

17. The power system of claim 16, wherein the power supply element and the AC switch are in series with an AC power source for generating the AC signal and a light source.

18. The power system of claim 16, wherein the logic is configured to control the AC switch such that the AC switch is disabled during each of the intermittent pulses and enabled between the intermittent pulses.

19. The power system of claim 16, wherein the logic is configured to detect zero-cross points in the AC signal and to control the power supply circuit based on detections of the zero-cross points.

20. The power system of claim 16, further comprising a load coupled to the AC switch, wherein the AC switch controls an operational state of the load, wherein the logic is configured to perform dimming operations based on user input by controlling the AC switch such that power delivered to the load is reduced when the load is activated, wherein the logic is configured to automatically determine whether the load is reactive, and wherein the logic is configured to automatically disable the dimming operations in response to a determination by the logic that the load is reactive.

21. A method for use in a lighting system, comprising the steps of:
receiving an alternating current (AC) signal from an AC power source;
selectively enabling a power supply circuit such that intermittent pulses from the AC signal are transmitted by the power supply circuit to a capacitor thereby charging the capacitor;
powering direct current (DC) components of the lighting system via a DC signal transmitted by the capacitor; and
selectively enabling an AC switch that is in parallel with the power supply circuit,
wherein the power supply circuit and the AC switch are in series with the AC power source and a light source, and wherein the AC signal bypasses the power supply circuit when the AC switch is enabled.

22. The method of claim 21, further comprising the step of detecting zero-cross points of the AC signal, wherein the selectively enabling the power supply circuit step is based on the detecting step.

23. The method of claim 22, wherein the selectively enabling the AC switch step is based on the detecting step.

24. The method of claim 21, further comprising the step of automatically disabling the AC switch based on a voltage of the AC signal.

25. The method of claim 24, further comprising the step of repetitively pulsing the AC switch with a control signal in response to a determination that the AC switch is to be enabled.
